(19) United States
(12) Patent Application Publication
(10) Pub. No.: US 2008/0086360 A1
(43) Pub. Date: Apr. 10, 2008

(54) SYSTEM AND METHOD FOR ADVERTISING VIA MOBILE DEVICES

(76) Inventors: Rajesh Kanapur, Ypsilanti, MI (US); Chunhui Li, Mukilteo, WA (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/867,925

(22) Filed: Oct. 5, 2007

Related U.S. Application Data
(60) Provisional application No. 60/850,330, filed on Oct. 6, 2006.
(60) Provisional application No. 60/972,545, filed on Sep. 14, 2007.

(51) Int. Cl. G06Q 30/00; G06F 17/40; G06F 19/00

(52) U.S. Cl. 705/10; 705/14

(57) ABSTRACT

A system and method for advertising via mobile devices is disclosed. The system includes a mobile device, a server and a network for providing communication between the mobile device and then server. According to one embodiment, the mobile device has a user input device and an advertisement interface. The server downloads an advertisement to the mobile device for display by the advertisement interface and tracks and stores information in response to the advertisement being viewed by a user. The method includes the steps of downloading an advertisement from an advertisement server to a mobile device, selecting the downloaded advertisement by a user of the mobile device, responding to the user selection, and the tracking of information by the advertising server.

### BACKGROUND OF THE INVENTION

The present invention relates generally to advertising and, more particularly, to a system and method for presenting advertising to mobile cellular device users.

Advertisements are prolific in today's society. Whether we're watching television, listening to the radio, reading a magazine, walking down the street, sitting in a stadium, or even surfing the Internet we are inundated with advertising. Advertising not only helps to generate revenue for the advertiser but also generates revenue for the advertisement host. Due to the vast number of advertisements we encounter every day combined with the high cost of advertising, companies are always looking to get the most exposure and results from their advertising dollars. This has led to methods of targeted advertising based on consumer interests and methods of performance-based advertising. One of the most common methods of performance-based advertising is encountered on the Internet and known as banner ads. These ads serve as a hyperlink and upon clicking the advertisement, the consumer is taken to a separate website. Instead of paying the host of these advertisements a flat fee for ad space, the advertiser pays the host based partly on the number of “clicks” that the ad receives. This arrangement allows the advertiser to ensure that its advertising dollars are being spent more wisely since it is paying for leads that are more promising since the consumer chose to click on the ad.

Advertisers are constantly in a race to find the most cost-effective yet targeted advertising methods that will generate interest in today's interactive and technological society that is already inundated with advertisements. Therefore, there is a need for a performance driven, incentive-based targeted advertising method that provides consumer interaction via a largely untapped advertising medium.

### SUMMARY OF THE INVENTION

The present invention concerns advertising. More specifically, the present invention is a system and method of presenting incentive-based interactive advertisements to a targeted group of consumers via an internet enabled device, preferably a mobile device such as a cellular phone.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a block diagram of a system in accordance with the present invention;

FIG. 2 is a flow diagram of a pay per click advertising method in accordance with the present invention;

FIG. 3 is a flow diagram of a first type of pay per call advertising method in accordance with the present invention;

FIG. 4 is a flow diagram of a second type of pay per call advertising method in accordance with the present invention;

FIG. 5 is a flow diagram of a third type of pay per call advertising method in accordance with the present invention; and

FIG. 6 is a flow diagram of a pay per view advertising method in accordance with the present invention.

### DESCRIPTION OF THE PREFERRED EMBODIMENT

The present invention concerns advertising. More specifically, the present invention is a system and method for providing interactive advertisements to consumers via mobile devices.

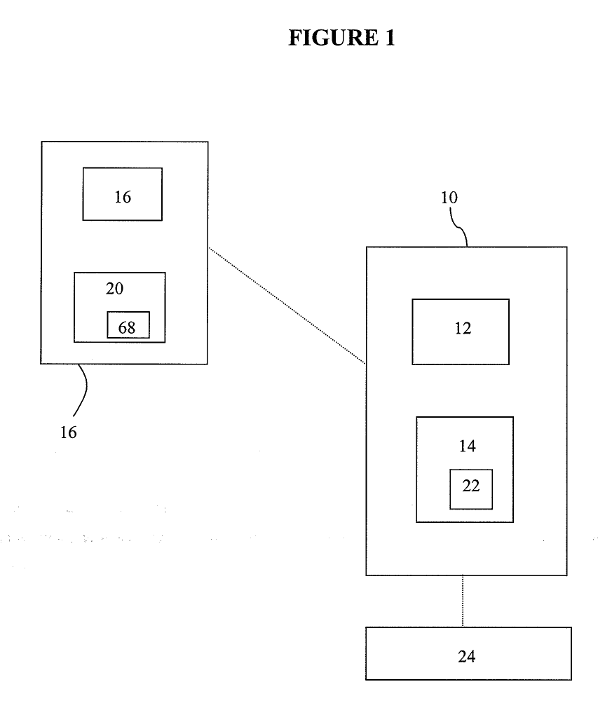

Referring to FIG. 1, the preferred embodiment of the present invention includes an advertising server 10 having a server application 12 and storage space 14. The server application 12 interacts with a client application 16 installed on a mobile device 18 having at least limited internet access, a user input device (not shown), storage 20, and is preferably a mobile cellular device. The client application 16 and server application 18 may communicate via a network using internet protocols and/or cellular protocols. On a broad level, when the user is running the client application 16 on the mobile device 18, the server application 12 pushes different types of advertisements to the user's mobile device 18 via the client application 16. The user will then have the option to interact with the ad and may preferably be given multiple options with respect to the type of advertisement the user desires to view.

Preferably, the present invention provides for targeted advertising. The server application 12 uses data collected about the user via a registration process and/or collected over the course of different activities or actions taken by the user on his/her mobile device 18 while the client application 16 is running. This user data is preferably stored in a user information database 22 in the storage space 14 of the advertising server 10. An example of such activity information might include tracking what types of advertisements the user has chosen to view in the past. Once the system has this user data, the system can use it to send the user advertisements for advertisers that are similar to those which the user has previously responded. Advertisers can also use this user information to target users who have particular interests and characteristics. The user information could also be used to provide demographic information to advertisers providing them with insight as to what types of users view their advertisements, consumer trends, etc. The possibilities of the types of information collected and the uses of this collected information are endless.

While it is preferred that the system provides targeted advertising, discussion of targeted advertising and storing user information is not meant to be limiting to the scope of the invention and could be eliminated without affecting the scope of the invention.

The preferred embodiment of the advertising deployment system also preferably includes an incentive system for the user similar to the incentive systems used by credit card companies and retail stores in which consumers accumulate incentive points when they make purchases and then are able to use those incentive points to “buy” certain rewards such as products, gift certificates, discounts, and the like. According to the preferred embodiment of the present invention, the advertising server 10 maintains a record of the number of incentive points earned by the user in the user information database 22. Incentive points are preferably earned when the user views, watches, interacts with, or performs various actions requested by the advertisements. The client application 16 and server application 12 then provide the user with ways in which to use or redeem his/her incentive points. One skilled in the art will appreciate that the system of the present invention as disclosed does not require an incentive system in order to carry out the other objects of the invention.

The system of the invention also preferably maintains an advertiser interface 24 that allows the advertisers to log in and interact with various parts of the advertising server 10. The advertiser interface 24 may allow advertisers to perform a variety of functions including but not limited to, uploading or creating advertisements, choosing targeted audiences for their advertisements, reviewing the success of their advertisements in terms of the percentage of users interacting with their ads, and viewing the amount currently due to the host/owner of the system for their advertising.

The system of the present invention provides multiple types of advertising to advertisers and to the user of the system. The types of advertisements are described hereinbelow and are organized by the interaction required by the user of the system for the host to collect revenue from the advertiser. There are three main categories of advertisements under the system of the present invention. The first type is the pay per click advertisement in which the advertiser pays a fee for the advertisement and the user receives incentive points for the advertisement upon simply clicking the advertisement. The second type of advertisement scheme is the pay per call advertisement which requires a call to be placed by the user or authorized by the user before the advertiser must pay for the ad and the user can collect incentive points. The third type of advertising scheme under the present invention is the pay per view model in which the user must view and/or interact with a multimedia ad in order for the advertiser to be charged and for the user to be rewarded with incentive points. Each of these three types of advertising schemes is discussed in more detail hereinbelow but the preferred methods of deploying the advertisements and rewarding incentive points as discussed are for example only and are not meant to be limiting to the invention.

Pay Per Click

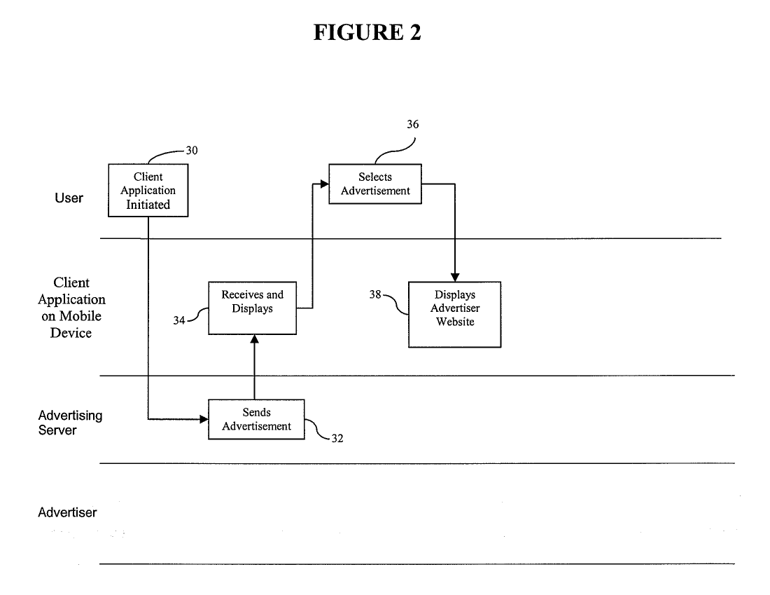

In accordance with the preferred embodiment of the present invention, the most basic type of advertising is the pay per click ad. Referring to FIG. 2, when the user has the mobile client 16 running on his/her mobile device 18, the server application 12 causes advertisement information (step 32) stored on the advertising server 10 or another server (not shown) accessible by the server application 12 to be sent to the user's mobile device 18 and displayed by the mobile client 16 (step 34). If the targeting feature is being utilized then the user is preferably targeted for the particular ad that is sent to his/her mobile device 18. The advertisement may take many forms; it may be a banner-type advertisement as commonly seen on Internet sites or may simply be a text banner that is stationary or scrolls across the screen of the user's mobile device 18 in a space reserved for advertising. If the user so chooses, he/she may click on the ad (step 36) which will cause the user to be taken to the advertiser's web site (step 38) or some other site designated by the advertiser since the ad serves as a hyperlink.

Once the user clicks the advertisement, the system preferably records the user's action in at least two ways. First, the system records the click by the user for purposes of charging the advertiser for the action taken by the user. Second, the system records the action taken by the user so that the user's information in the user information database 22 may be updated and the user's incentive point balance may be increased if an incentive system is being utilized.

Pay Per Call

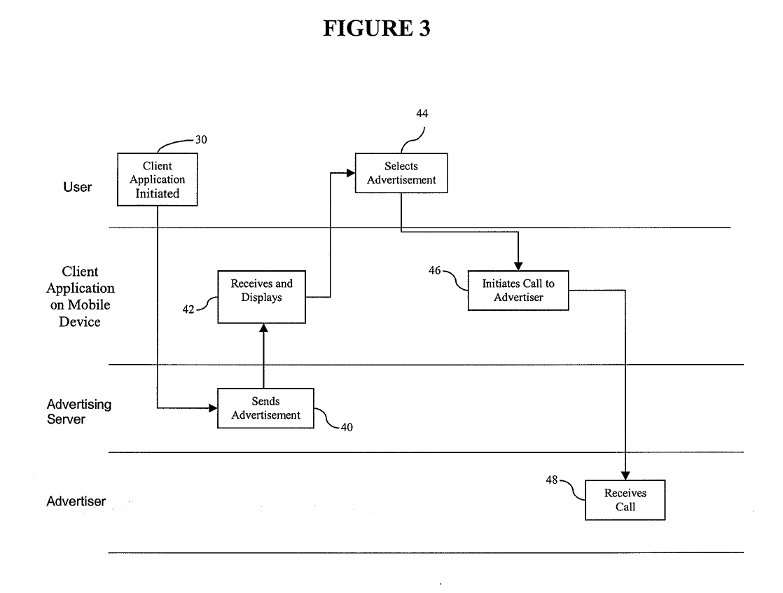

According to the present invention, there are three different types of pay per call advertisements as exemplified in FIGS. 3 through 5. For each of the three pay per call types, when the user has the mobile client 16 running on his/her mobile device 18 (step 30), the server application 12 causes advertisement information stored on the advertising server 10 or another server (not shown) accessible by the server application 12 to be sent to the user's mobile device 18 (step 40) and displayed by the client application 16 (step 42). Again, it is preferred but not necessary that the user receive an ad for which he/she was targeted based on information known about him/her by the system. The advertisement may take many forms; it may be a banner-type advertisement as commonly seen on Internet sites or may simply be a text banner that is stationary or scrolls across the screen of the user's mobile device. If the user so chooses, he/she may click on the ad (step 44). The next step differs depending on the type of pay per call advertisement.

Referring to FIG. 3, the first type of pay per call advertisement in accordance with the present invention results in a direct call to the advertiser. Once the user clicks on the advertisement (step 44), the mobile client 16 causes the user's mobile device 18 to place a direct call to the advertiser (step 46). As a result, the advertiser is in receipt of a call from the user (step 48).

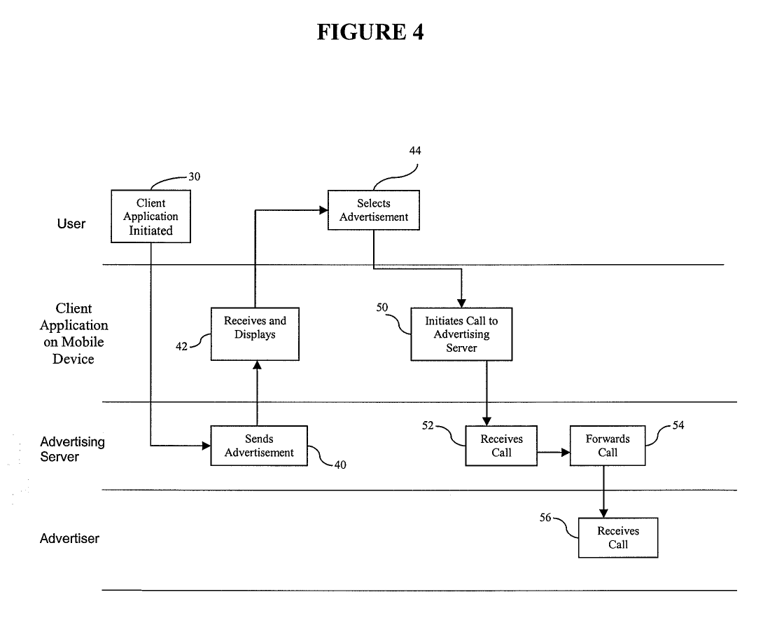

Referring to FIG. 4, the second type of pay per call advertisement in accordance with the present invention results in an indirect call to the advertiser. Once the user clicks on the advertisement (step 44), the mobile client 16 causes the user's mobile device 18 to call the advertising server 10 (step 50) or another server (not shown) associated with the advertising server. In turn, in steps 52 and 54 the server receives the call from the user and then forwards the call to the advertiser. Finally, the advertiser is in receipt of a call from the user (step 56). This indirect call method is less intrusive to the user as it prevents the advertiser from obtaining the user's phone number unless the user provides the same to the advertiser during the call.

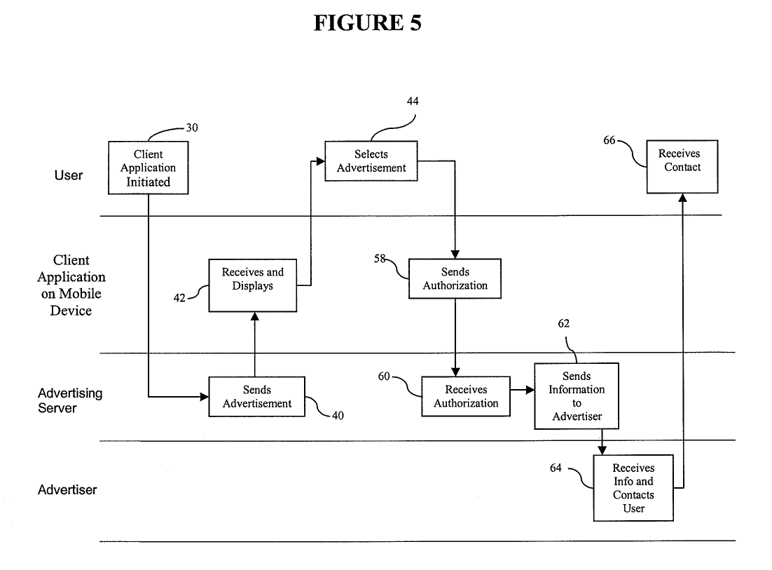

Referring to FIG. 5, the third type of pay per call advertisement in accordance with the present invention results in the advertiser receiving an authorization to call the user. In this type of pay per call advertisement, by clicking on the ad in step 44 the user is authorizing the advertiser to call him/her. Then, the mobile client 16 causes the authorization to be sent to the advertising server 10 (step 58). The advertising server 10 or another server (not shown) associated with the system receives the authorization message (step 60) and then the server sends the user's phone number to the advertiser (step 62). The advertiser can then place a call (step 64) to the user who receives the call on his/her mobile device (step 66).

In all three of the pay per call methods, once the user has passed a certain predetermined threshold such as clicking the advertisement or following through with an actual call to/from the advertiser, the system records the action for purposes of charging the advertiser for the action taken by the user. The system also records the action so that the user's incentive point balance may be increased and the user's actions are updated in the user information database 22.

Pay Per View

A pay per view type of advertisement is preferably an advertisement in the form of a game, a video clip, an audio clip, or an audio/video clip. According to the preferred embodiment of the present invention, the system includes advertisement templates 68 for the various types of advertising formats and loads the basic templates onto the user's mobile device 18 via the mobile client 16. Advertisers can personalize the templates using different colors, fonts, etc and then upload the personalized ad information to the system. Then, only the personalization information needs to be sent to the user's mobile device when a particular ad is sent to the user. This greatly reduces the amount of time that loading an entire advertisement would take. This is also advantageous to smaller advertisers who do not have a large advertising budget and/or do not need to make sure that all of its advertisements across all advertising mediums have the exact same look and feel. In sum, this template method allows for reduced costs in advertisement creation on the advertiser's end and reduced download times for the users.

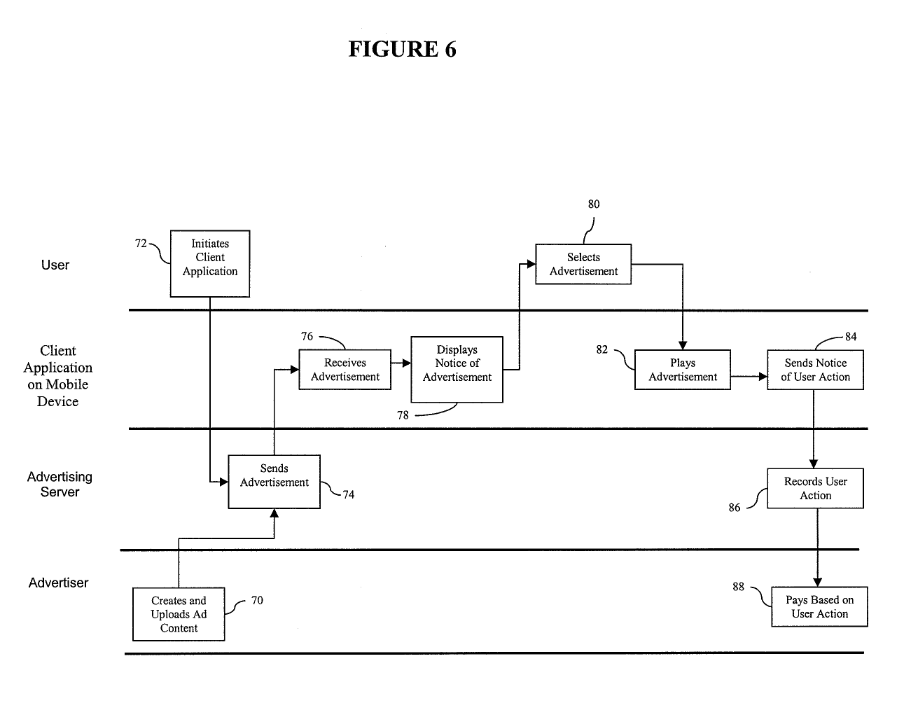

While the templates may be utilized for any of the three types of advertising schemes, it is most advantageous to use the templates for the pay per view due to the multimedia nature of the pay per view ads. Referring now to FIG. 6, the first step in the process is the advertiser uploading the ad content to the system (step 70). The ad content may or may not take advantage of the ad templates provided by the system and already loaded on the user's mobile device 18. When the user has the mobile client 16 running on his/her mobile device 18 (step 72), the server application 12 causes the advertisement information stored on the advertising server 10 or another server (not shown) accessible by the server application 12 to be sent to the user's mobile device 18 if the user falls within the targeted demographic chosen by the advertiser (step 74). The mobile client 16 receives (step 76) and displays a notice of the pay per view advertisement to the user (step 78). The advertisement notice may take many forms; it may be a banner-type advertisement as commonly seen on Internet sites or may simply be a text banner that is stationary or scrolls across the screen of the user's mobile device. If the user so chooses, he/she may click on the ad notice (step 80) and choose the type of pay per view ad he/she wishes to view, if that option is provided. For example, in some scenarios the user may be able to choose between an ad game, an audio/video clip, or an audio only ad.

Then, in step 82 the mobile client 16 causes the pay per view ad to be played on the user's mobile device. Once a particular threshold has been met, for example the user has played the game for a predetermined amount of time or has watched an entire video clip, the mobile client 16 causes the system to record completion of the action for purposes of charging the advertiser for the action taken by the user (steps 84 through 88). The system also records the action so that the user's incentive point balance may be increased and records the action into the user information database 22 for purposes of using that data to later target the user for other advertisements.

One skilled in the art will appreciate that the system and method of the current invention is essentially a module that can be included in a variety of larger systems. If included as part of a larger system, it is anticipated that the actions taken by the user and preferences shown by the user on that larger system can also be stored in a user information database and used to target the user for particular advertisements. The above examples of the system operation is meant only as illustrations of a possible way to carry out the invention but details can be changed without straying from the scope of the invention. For example, email addresses or non mobile telephone numbers could be shared with advertisers instead of cellular telephone numbers. As stated above, the advertisements could not be targeted to certain users but instead be broadcast to all or even random users of the system. In addition, the system could operate without an incentive point system or on some other type of incentive system. Instead of gaining incentive points for viewing advertisements, users could choose to view ads instead of paying for certain goods and/or services or in order to receive a discount or special offer on goods and/or services. Further, the system could be configured to operate on noncellular devices having internet connectivity.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for transmitting advertisements on a mobile device comprising the steps of:
downloading an advertisement to the mobile device using an advertisement server;
selecting the downloaded advertisement on said mobile device by a user of the mobile device;
responding to said user selection; and
tracking said selection and additional information by said server.

2. The method of claim 1 wherein the step of responding to said user selection comprises the step of connecting the mobile device to a second server in response to the user selection.

3. The method of claim 1 wherein the step of responding to said user selection comprises the step of causing the mobile device to initiate a telephone call.

4. The method of claim 1 wherein the step of responding to said user selection comprises the step of causing the user to receive a telephone call.

5. The method of claim 1 wherein the step of responding to said user selection comprises the step of displaying one of an audio, video, and audio/video file on said mobile device.

6. The method of claim 1 further comprising the step of providing incentives to the user for selecting said downloaded advertisement.

7. The method of claim 1 further comprising providing compensation to the advertisement server owner by an advertiser.

8. The method of claim 7 wherein the compensation provided is in response to the user interacting with said downloaded advertisement.

9. The method of claim 1 further comprising the step of exchanging information between said server and said mobile device.

10. The method of claim 1 wherein said downloaded advertisement is interactive.

11. The method of claim 1 further comprising installing an interactive advertisement viewing interface on said mobile device.

12. The method of claim 1 further including the step of targeting a user to receive an advertisement.

13. The method of claim 12 further including the step of using the tracked selection and additional information to target a user.

14. The method of claim 1 further comprising the step of providing a plurality of advertisement templates.

15. The method of claim 14 further comprising the step of personalizing at least one of said plurality of advertisement templates.

16. A system for displaying advertisements on a mobile device comprising:
a server;
a network;
and a mobile device in communication with said server via said network, said mobile device comprising: an advertisement interface and a user input device; wherein said server downloads an advertisement to the mobile device for display by the advertisement interface; and wherein the server tracks and stores information in response to the advertisement being viewed by a user.

17. The system of claim 16 further comprising a communication connection to a second server in response to the downloaded advertisement.

18. The system of claim 16 further comprising a communication connection to a telephone system in response to the downloaded advertisement.

19. The system of claim 16 further comprising a communication connection with an advertiser in response to the downloaded advertisement.

20. The system of claim 16 further comprising an incentive system in communication with said server to provide benefits to the user for responding to the downloaded advertisement.

21. The system of claim 16 further comprising a compensation system in communication with said server to provide compensation to the owner of said server by an advertiser in response to a user responding to said downloaded advertisement.

22. The system of claim 16 wherein the advertising interface includes a screen space reserved for advertising.

23. The system of claim 16 further comprising a targeting system in communication with said server to target the mobile device to receive the advertisement.

24. The system of claim 16 further comprising an advertising template system in communication with said server and said mobile device wherein said advertising template system downloads advertisement templates to the mobile device separately from said downloaded advertisement.

25. The system of claim 24 wherein said advertising template system further includes an advertiser interface adapted to allow an advertiser to personalize the advertising templates.
